(19) United States
(12) Patent Application Publication
(10) Pub. No.: US 2026/0252492 A1
(43) Pub. Date: Aug. 27, 2026

(54) STORAGE DEVICE AND OPERATING METHOD OF THE SAME

(71) Applicant: SK hynix Inc., Icheon-si (KR)

(72) Inventors: Hye Mi KANG, Icheon-si (KR); Min Jun JANG, Icheon-si (KR)

(21) Appl. No.: 19/414,090

(22) Filed: Dec. 9, 2025

(30) Foreign Application Priority Data
Feb. 25, 2025 (KR) 10-2025-0024366
Jul. 18, 2025 (KR) 10-2025-0097093

(51) Int. Cl. G06F 12/0871; G06F 12/10

(52) U.S. Cl. CPC G06F 12/0871; G06F 12/10

(57) ABSTRACT

According to an embodiment of the disclosed technology, a storage device is provided. The storage device comprises a first memory device configured to store data, a second memory device including a first cache memory configured to store mapping information between physical data addresses and logical data addresses of the stored data and a second cache memory configured to store segments of the mapping information, and a memory controller in communication with the first memory device and the second memory device and configured to update the mapping information in response to a write request received from an external host device, in which the memory controller is configured to allocate a first region among regions of the second cache memory for the mapping information in response to determining that a size of a workload corresponding to the write request is less than or equal to a first threshold value.

### PRIORITY CLAIM AND CROSS-REFERENCE TO RELATED APPLICATION

This patent document claims the priority and benefits of Korean patent application number 10-2025-0024366, filed on Feb. 25, 2025, and Korean patent application number 10-2025-0097093, filed on Jul. 18, 2025, which are incorporated herein by reference in their entirety.

### TECHNICAL FIELD

The technology and implementations disclosed in this patent document generally relate to a storage device and an operating method thereof.

### BACKGROUND

A memory device stores data in response to a write request and outputs stored data in response to a read request. For example, a memory device may be a volatile memory device, such as Dynamic Random Access Memory (DRAM), Static RAM (SRAM), etc., which are volatile memory devices where stored data is lost when power is cut off, and non-volatile memory devices such as flash memory devices, Phase-change RAM (PRAM), Magnetic RAM (MRAM), Resistive RAM (RRAM), etc., which retain stored data even when power is cut off.

A memory device may update mapping information between a logical address and a physical address based on the logical address and a write request received from a host device. However, the space in a cache memory that stores the mapping information is limited, and a map update operation that flushes the mapping information stored in the cache memory may cause overhead and reduce the durability of the memory device. Therefore, a technique to increase a cycle of the map update operation may be required.

### SUMMARY

Various embodiments are directed to a storage device that allocates a portion of a cache memory for data stored in another cache memory, and an operating method of the storage device.

According to an embodiment, a storage device may comprises a first memory device configured to store data, a second memory device including a first cache memory configured to store mapping information between physical data addresses and logical data addresses of the stored data and a second cache memory configured to store segments of the mapping information, and a memory controller in communication with the first memory device and the second memory device and configured to update the mapping information in response to a write request received from an external host device, wherein the memory controller is configured to allocate a first region among regions of the second cache memory for the mapping information in response to determining that a size of a workload corresponding to the write request is less than or equal to a first threshold value.

According to an embodiment, a storage device may comprise a first memory device configured to store data, a second memory device including a first cache memory configured to store mapping information between physical data addresses and logical data addresses of the stored data and a second cache memory configured to store segments of the mapping information, and a memory controller in communication with the first memory device and the second memory device and configured to allocate a first region among regions of the second cache memory for the mapping information, wherein the memory controller is configured to: in response to receiving a write request from an external host device, determine whether a cache hit or a cache miss occurs for a segment corresponding to the write request, modify the segment in response to the cache hit for the segment, and update the mapping information in response to the cache miss for the segment.

### BRIEF DESCRIPTION OF THE DRAWINGS

FIG. 1 is a block diagram of an electronic system according to an embodiment of the disclosed technology.

FIG. 2 is a block diagram of a storage device according to an embodiment of the disclosed technology.

FIG. 3 is a flowchart illustrating an operating method of a storage device according to an embodiment of the disclosed technology.

FIG. 4 is a diagram illustrating a storage device according to some embodiments of the disclosed technology.

FIG. 5 is a flowchart illustrating an operating method of a storage device according to some embodiments of the disclosed technology.

FIG. 6 is a diagram illustrating a storage device according to some embodiments of the disclosed technology.

FIG. 7 is a flowchart illustrating an operating method of a storage device according to some embodiments of the disclosed technology.

FIG. 8 is a flowchart illustrating an operating method of a storage device according to some embodiments of the disclosed technology.

FIG. 9 is a flowchart illustrating an operating method of a storage device according to some embodiments of the disclosed technology.

FIG. 10 is a diagram illustrating a second memory device according to some embodiments of the disclosed technology.

FIG. 11 is a block diagram illustrating a memory card system to which a storage device according to some embodiments of disclosed technology is applied; and

FIG. 12 is a block diagram illustrating an electronic system according to embodiments of the disclosed technology.

### DETAILED DESCRIPTION

Hereinafter, embodiments of the disclosed technology will be described in detail and clearly so that those skilled in the art to which the disclosed technology pertains can easily carry out the invention.

It will be understood that, although the terms “first”, “second”, etc. may be used herein to describe various elements, these elements should not be limited by these terms. These terms are only used to distinguish one element from another element.

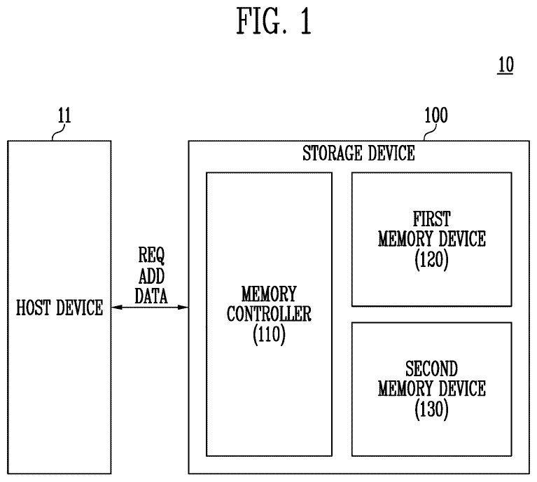

FIG. 1 is a block diagram of an electronic system 10 according to an embodiment of the disclosed technology. Referring to FIG. 1, the electronic system 10 may be a computing system configured to process various information or to store processed information as data. In some embodiments, the electronic system 10 may be implemented as a personal computer (PC), a notebook, a laptop, a server, a workstation, a tablet PC, a smartphone, a digital camera, a black box, etc.

The electronic system 10 may include a host device 11 and a storage device 100. The host device 11 may control various operations of the electronic system 10. More specifically, the host device 11 may control the operations of other components including the electronic system 10. The host device 11 may be implemented as a general-purpose processor, a dedicated processor, or an application processor (AP).

The host device 11 may communicate with the storage device 100. For example, the host device 11 may request program operations, read operations, erase operations, etc., from the storage device 100. The host device 11 may transfer a host request REQ, data DATA, and a logical address ADD to the storage device 100 for a program operation of the storage device 100. For example, the host device 11 may transfer the host request REQ and the logical address ADD to the storage device 100 for a write operation of the storage device 100. A set of the host request REQ, the data DATA, and the logical address ADD which are provided by the host device 11 to the storage device 100 may be referred to as a workload.

In some embodiments, the host request REQ for a write operation may indicate a sequential write operation or a random write operation. A sequential write operation may be an operation where consecutive data corresponding to logical addresses are written sequentially to the storage device 100. In addition, a random write operation may be an operation where non-consecutive data corresponding to logical addresses are written to the storage device 100.

The storage device 100 may store data. For example, the storage device may store data under the control of the host device 11. In some embodiments, the storage device 100 may include at least one of an Solid State Device (SSD), embedded memory, and removable external memory. When the storage device 100 is an SSD, the storage device 100 may conform to the Non-Volatile Memory Express (NVMe) standard. When the storage device 100 is embedded memory or removable external memory, the storage device 100 may conform to the Universal Flash Storage (UFS) or embedded Multi-Media Card (eMMC) standard. The host device 11 and the storage device 100 may each generate packets based on the adopted standard protocol and transfer the generated packets to each other.

The storage device 100 may include a memory controller 110, a first memory device 120, and a second memory device 130. The memory controller 110 may control the operation of the storage device 100. For example, the memory controller 110 may control the operation of the storage device 100 according to internal policies or in response to the host request REQ. The memory controller 110 may store the data DATA in the first memory device 120 or read the data DATA stored in the first memory device 120, based on internal policies or in response to the host request REQ.

The memory controller 110 may generate a program command and provide the generated program command to the first memory device 120 in response to the host request REQ corresponding to a program operation received from the host device 11. The memory controller 110 may generate a write command and provide the generated write command to the first memory device 120 in response to the host request REQ corresponding to a write operation received from the host device 11.

The memory controller 110 stores mapping information between the logical address ADD and a physical address in the second memory device 130, and in response to a write request, may update the mapping information. For example, in response to the write request, the memory controller 110 may provide a write command, a physical address, and the data DATA to the first memory device 120, and may update the mapping information between the logical address ADD and the physical address in the second memory device 130. In some embodiments, the mapping information stored in the second memory device 130 may include physical-to-logical (P2L) mapping information.

The memory controller 110 may perform map update operations. For example, the memory controller 110 may perform a map update operation which flushes the mapping information stored in the second memory device 130 to the first memory device 120 and erases the mapping information from the second memory device 130. The map update operation may cause significant overhead and reduce the endurance of the second memory device 130.

The memory controller 110 may perform a map update operation in response to various factors. For example, the memory controller 110 may perform the map update operation in response to determining that there is insufficient additional space within the second memory device 130 to update the mapping information. Therefore, the size of the space within the second memory device 130 for storing the mapping information may be directly related to the frequency of the map update operation, and consequently, may be related to the performance of the storage device 100 or the electronic system 10 and the durability of the storage device 100. Therefore, within the limited space of the second memory device 130, it is necessary to secure additional space or regions for mapping information.

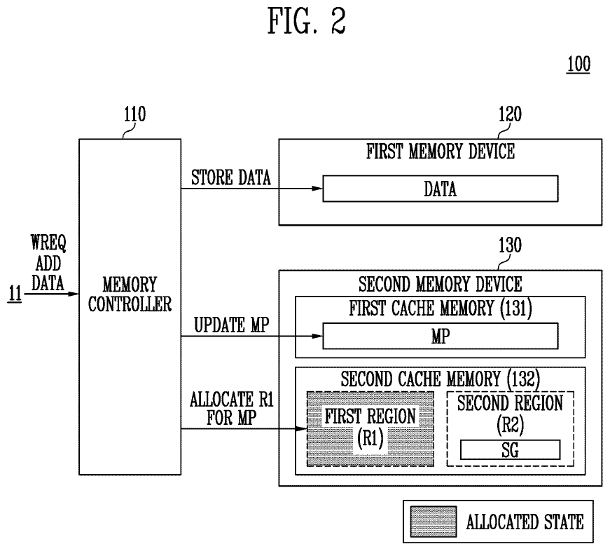

A more detailed description of how the memory controller 110 secures additional space or regions for mapping information will be provided below with reference to FIGS. 2 to 9.

The first memory device 120 may store the data DATA under the control of the memory controller 110. For example, the first memory device 120 may store metadata, which includes user data received from the host device 11 and mapping information or segments received from the second memory device 130 via a map update operation.

The first memory device 120 may be a non-volatile memory device such as NAND Flash memory, but the scope of the disclosed technology is not limited thereto. The first memory device 120 may be one of various devices capable of retaining stored data even when power is cut off, such as Phase-change Random Access Memory (PRAM), Magnetic Random Access Memory (MRAM), Resistive Random Access Memory (RRAM), or FRAM Ferroelectric Random Access Memory.

The second memory device 130 may store mapping information or segments under the control of the memory controller 110. In some embodiments, the second memory device 130 may temporarily store the mapping information between the logical address ADD and the physical address, and may then provide the stored mapping information to the first memory device 120 via the map update operation.

The second memory device 130 may be one of various devices such as a Dynamic Random Access Memory (DRAM), Static Random Access Memory (SRAM), Double Data Rate Synchronous Dynamic Random Access Memory (DDR SDRAM), Low Power Double Data Rate 4 (LPDDR4) SDRAM, Graphics Double Data Rate (GDDR) SDRAM, Low Power DDR (LPDDR), Rambus Dynamic Random Access Memory (RDRAM), and the like.

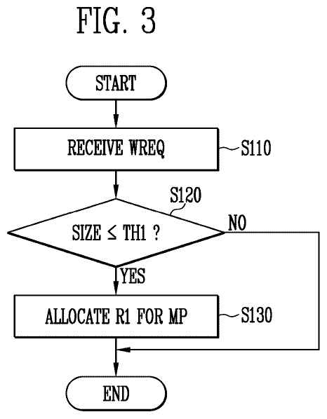

Since the operation speed of the second memory device 130 (e.g., a speed of a write operation or a speed of a read operation) is relatively faster than the operation speed of the first memory device 120, the memory controller 110 may quickly store or update mapping information in the second memory device 130. Therefore, the storage device 100 may use a portion of the second memory device 130 to cache the mapping information. A more detailed description thereof will be provided below with reference to FIGS. 2 and 3.

In FIG. 1, the second memory device 130 is exemplarily described as being placed outside the memory controller 110, but the scope of the disclosed technology is not limited thereto. The second memory device 130 may be included within the memory controller 110.

FIG. 2 is a block diagram of the storage device 100 according to an embodiment of the disclosed technology. Referring to FIG. 2, the storage device 100 may include the memory controller 110, the first memory device 120, and the second memory device 130. The memory controller 110, the first memory device 120, and the second memory device 130, which are shown in FIG. 2, are similar to the memory controller 110, the first memory device 120, and the second memory device 130, which are shown in FIG. 1. Therefore, redundant descriptions of these components will be omitted hereafter.

The second memory device 130 may include a first cache memory 131 and a second cache memory 132. The first cache memory 131 may store mapping information MP, and the second cache memory 132 may store segments (e.g., L2 segments) SG.

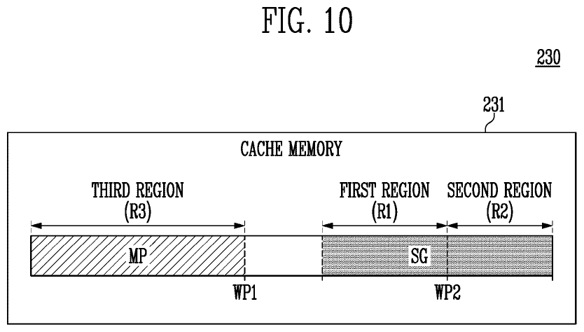

For ease of understanding the disclosed technology, the first cache memory 131 and the second cache memory 132 are exemplarily illustrated as separate cache memories, but the scope of the disclosed technology is not limited thereto. The first cache memory 131 and the second cache memory 132 may be implemented as a single cache memory. Furthermore, the second memory device 130 may include at least two or more cache memories as needed. A more detailed description of an embodiment where the first cache memory 131 and the second cache memory 132 are implemented as a single cache memory will be provided below with reference to FIG. 10.

In some embodiments, the first cache memory 131 may be used as a cache area storing the mapping information MP for a write operation of the storage device 100, and the second cache memory 132 may be used as a cache area storing segments SG for a read operation of the storage device 100. For example, the first cache memory 131 may store and update the mapping information MP between the physical address and the logical address ADD of the data DATA to be stored in the first memory device 120, and the second cache memory 132 may cache the segments SG of data to be read from the first memory device 120.

The memory controller 110 may use a portion of the second cache memory 132 to handle a write request WREQ (or the workload of the write request WREQ). For example, when requests received from the host device 11 are predominantly the write requests WREQ or when the workload of the read request is small, the memory controller 110 may allocate a portion (e.g., a first region R1) of regions (e.g., first and second regions R1 and R2) of the second cache memory 132 for the mapping information MP, and may load and cache segments corresponding to the write request WREQ. The write request and the read request may be the host request REQ in FIG. 1, which refers to a write operation and a read operation, respectively.

In some embodiments, the sizes of the regions (e.g., the first and second regions R1 and R2) in the second cache memory 132 may be variable as needed. In some implementations, the second memory device 130 may include at least three cache memories, and the memory controller 110 may exemplarily allocate at least one of the three or more cache memories as the first region R1.

In some embodiments, the memory controller 110 may load a segment corresponding to the write request WREQ into the first region R1 or modify an already loaded segment, instead of updating the mapping information MP stored in the first cache memory 131 based on the write request WREQ. The memory controller 110, by allocating the first region R1 for the mapping information MP (e.g., by loading or modifying the segment corresponding to the write request WREQ into the first region R1 instead of updating the mapping information MP), can handle more write requests WREQ and their workloads until all available space within the first cache memory 131 is exhausted (e.g., until all space for updating the mapping information MP is exhausted). Therefore, the update frequency of updating the mapping information MP can be reduced, and the cycle or period of the map update operation can increase.

However, when the memory controller 110 indiscriminately allocates a portion (e.g., the first region R1) of the first cache memory 131 for the mapping information MP, it may cause a performance degradation of the storage device 100. For example, when the workload of the write request WREQ exhibits low locality (e.g., when the number of segments corresponding to the write request WREQ is large or the workload size exceeds a threshold), all segments corresponding to the write request WREQ may not be loaded into the first region R1, leading to more frequent map update operations. Therefore, the memory controller 110 may perform map update operations at shorter intervals than when part of the first cache memory 131 (e.g., the first region R1) is not allocated for the mapping information MP. This may further degrade the performance of the storage device 100.

Therefore, in some implementations, the memory controller 110 selectively allocates a portion of the first cache memory 131 (e.g., the first region R1) for mapping information if a certain condition is met. For example, such selective allocation is performed based on a locality check. For example, the memory controller 110 may perform a comparison operation between the size of the workload corresponding to the write request WREQ and the threshold value. Based on the result of this comparison operation, the memory controller 110 may selectively allocate a portion (e.g., the first region R1) of the first cache memory 131 for the mapping information MP. For example, the memory controller 110 may allocate a portion (e.g., the first region R1) of the first cache memory 131 for the mapping information MP in response to determining that the size of the workload corresponding to the write request WREQ is less than or equal to the threshold (i.e., that locality is high).

In some implementations, in response to determining that the size of the workload corresponding to the write request WREQ is greater than the threshold, the memory controller 110 may deallocate the portion (e.g., the first region R1) of the first cache memory 131 and the segments corresponding to the write request WREQ may no longer be loaded into the deallocated first region R1 or modified. A more detailed description thereof will be provided below with reference to FIG. 3.

FIG. 3 is a flowchart illustrating the operation of the storage device 100 according to an embodiment of the disclosed technology. Referring to FIGS. 2 and 3, the memory controller 110 may selectively allocate a portion (e.g., the first region R1) of the first cache memory 131 for the mapping information MP based on the result of the comparison operation between the size of the workload corresponding to the write request WREQ and the threshold value.

In step S110, the memory controller 110 may receive the write request WREQ from an external host device 11. In some embodiments, the write request WREQ may correspond to one or more logical addresses. In other words, the workload corresponding to the write request WREQ may include at least one logical address. At least one logical address may correspond to at least one segment.

In step S120, the memory controller 110 may determine whether the size of the workload corresponding to the write request WREQ is less than or equal to a first threshold TH1. For example, based on the write request WREQ and the logical address ADD received from the external host device 11, the memory controller 110 may determine the number of segments corresponding to the write request WREQ (e.g., the size of the workload), and may determine whether the number of segments or the size of the workload is less than or equal to the first threshold TH1, thereby determining the locality of the workload corresponding to the write request WREQ. When the number of segments (or the workload size) is small, the locality of the workload corresponding to the write request WREQ is high; when the number of segments is large, the locality may be low.

In step S130, the memory controller 110 may allocate the first region R1 for the mapping information MP in response to determining that the workload size is less than or equal to the first threshold TH1 (e.g., that locality is high). For example, the memory controller 110 may allocate the first region R1 for the mapping information MP among the regions of the second cache memory 132 (e.g., the first and second regions R1 and R2).

In some embodiments, the memory controller 110 may store the data DATA corresponding to the write request WREQ in the first memory device 120, and may load a segment corresponding to the write request WREQ into the first region R1, or modify an already loaded segment.

In some embodiments, the memory controller 110 may update the mapping information MP corresponding to the write request WREQ in the first cache memory 131 in response to determining that the workload size is greater than the first threshold TH1 (e.g., that locality is low).

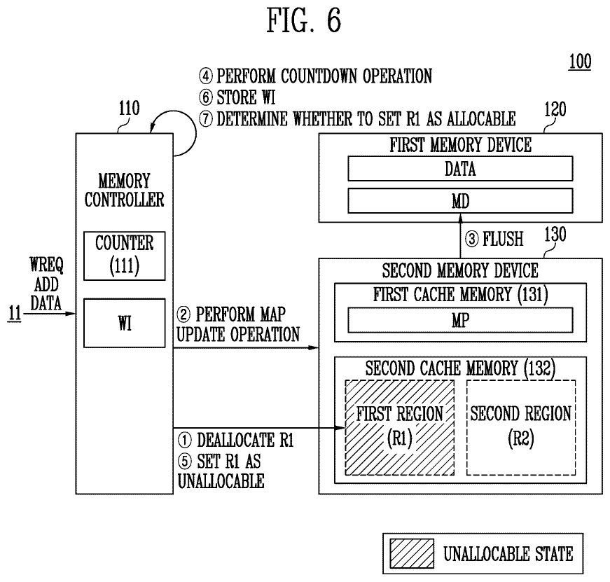

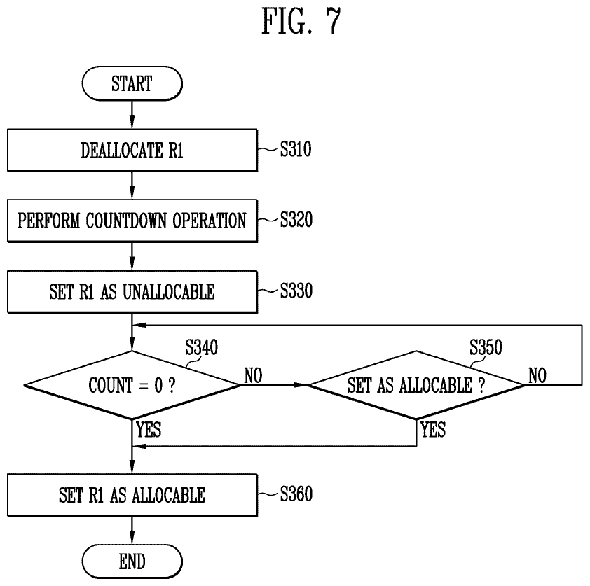

In some embodiments, the memory controller 110 may determine whether the first region R1 is in an allocable state as a requirement for allocating the first region R1 for the mapping information MP. When the first region R1 is in an allocable state, the memory controller 110 may allocate the first region R1 for the mapping information MP. However, when the first region R1 is not in the allocable state (e.g., in an unallocable state), the memory controller 110 may not allocate the first region R1 for the mapping information MP until the first region R1 becomes allocable again. A more detailed description of the allocable state of the first region R1 will be provided below with reference to FIGS. 6 and 7.

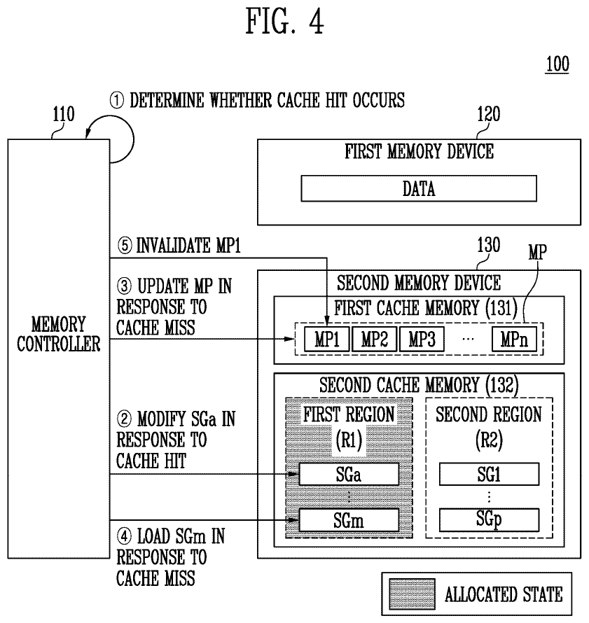

FIG. 4 is a diagram illustrating the storage device 100 according to some embodiments of the disclosed technology. Referring to FIGS. 2 and 4, the memory controller 110 may modify segments or update the mapping information MP based on whether a cache hit occurs in the first region R1.

In response to receiving the write request WREQ from the external host device 11, the memory controller 110 may load a segment corresponding to the write request WREQ into the first region R1 or modify the segment already loaded into the first region R1. In some embodiments, the operation of loading the segment into the first region R1 may require a greater overhead than the operation of modifying the segment already loaded into the first region R1. Therefore, when the segment corresponding to the write request WREQ is not loaded into the first region R1, the operation of updating the mapping information MP in the first cache memory 131 requires a shorter write time than the operation of loading the segment into the first region R1, and consequently may provide better write performance.

In some embodiments, the memory controller 110 determines whether the segment corresponding to the write request WREQ is a cache hit (e.g., the segment corresponding to the write request is loaded within the first cache region R1) or a cache miss (e.g., the segment corresponding to the write request is not loaded within the first cache region R1). In some implementations, when it is the cache miss, the memory controller 110 may first update the mapping information MP and then load the segment into the first region R1 by a background operation.

The first cache memory 131 stores the mapping information MP, and the mapping information MP may include a plurality of mapping entries MP1 to MPn. Each of the plurality of mapping entries MP1 to MPn may indicate mapping relationships between logical addresses and physical addresses. In addition, the second cache memory 132 may include the first and second regions R1 and R2, and the first and second regions R1 and R2 may store a plurality of segments SGa to SGm and SG1 to SGp, respectively, where n, m, and p are arbitrary natural numbers.

In some embodiments, when the memory controller 110 receives a read request corresponding to at least one segment loaded into the first region R1 from the external host device (not shown), the memory controller 110 may perform a read operation of the data DATA stored in the first memory device 120 based on the corresponding segment, and may provide the read data DATA to the external host device (not shown).

Operations to be described below, which include first to fifth operations \textcircled{1} to \textcircled{5}, are exemplary operations for facilitating the understanding of the disclosed technology and the scope of the disclosed technology is not limited thereto.

In the first operation \textcircled{1}, the memory controller 110 may determine whether a cache hit or a cache miss has occurred. For example, the memory controller 110 may determine that the cache hit has occurred, indicating that a segment corresponding to the write request WREQ received from the external host device 11 is loaded in the first region R1. For example, the memory controller 110 may determine that the cache miss has occurred, indicating that a segment corresponding to the write request WREQ received from the external host device 11 is not loaded in the first region R1.

In the second operation \textcircled{2}, the memory controller 110 may modify a segment in response to the cache hit (e.g., when the segment corresponding to the write request WREQ is loaded in the first region R1). For example, when the segment corresponding to the write request WREQ is an a-th segment SGa, the memory controller 110 determines that the segment SGa is loaded in the first region R1 (e.g., a cache hit), and may modify the segment SGa.

In the third operation \textcircled{3}, the memory controller 110 may update the mapping information MP in response to the cache miss (e.g., when the segment corresponding to the write request does not exist within the first region R1). For example, in response to the cache miss, the memory controller 110 may modify the first mapping entry MP1 corresponding to the logical address and the physical address associated with the write request WREQ within the mapping information MP stored in the first cache memory 131.

In the fourth operation \textcircled{4}, the memory controller 110 may load segments into the first region R1. For example, the memory controller 110 may update the mapping information MP corresponding to the write request WREQ (e.g., the first mapping entry MP1), and may then load an m-th segment SGm corresponding to the write request WREQ into the first region R1. In response to the cache miss, the memory controller 110 may load the m-th segment SGm into the first region R1 by a background operation after updating the mapping information MP, instead of loading the m-th segment SGm, so that overhead is immediately reduced and write performance is improved.

In the fifth operation \textcircled{5}, the memory controller 110 may invalidate a portion of the mapping information. For example, after loading the m-th segment SGm into the first region R1, the memory controller 110 may invalidate the first mapping entry MP1 corresponding to the write request WREQ in response to receiving an additional write request WREQ for the m-th segment SGm. By invalidating the first mapping entry MP1, the memory controller 110 may free up more space within the first cache memory 131.

In some embodiments, the memory controller 110 may retain the first mapping entry MP1 (without invalidating the first mapping entry MP1) when the memory controller 110 does not receive any additional write request WREQ for the m-th segment SGm after loading the m-th segment SGm into the first region R1 and until a subsequent map update operation.

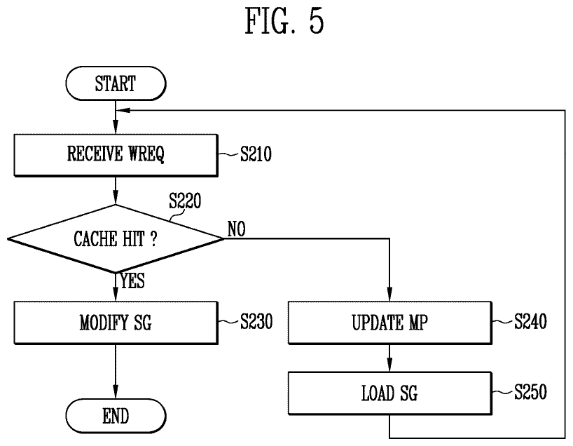

FIG. 5 is a flowchart illustrating an operating method of the storage device 100 according to some embodiments of the disclosed technology. Referring to FIGS. 4 and 5, the memory controller 110 may modify the segment SG already loaded into the first region R1 or update the mapping information MP, based on whether a cache hit or a cache miss occurs.

In step S210, the memory controller 110 may receive the write request WREQ. For example, the memory controller 110 may receive the write request WREQ corresponding to at least one segment SG.

In step S220, the memory controller 110 may determine whether a cache hit occurs. For example, the memory controller 110 may determine whether the cache hit or the cache miss occurs. The cache hit indicates that the segment SG corresponding to the write request WREQ is loaded in the first region R1, and the cache miss indicates that the segment SG corresponding to the write request WREQ is not loaded in the first region R1.

In some embodiments, when the received write request WREQ is the first write request WREQ received after the first region R1 is allocated, the memory controller 110 may determine a cache miss. In this case, the cache miss may be determined without determining whether a cache hit occurs. If the received write request WREQ is the first write request WREQ received after the first R1 is allocated, the memory controller 110 may perform the operation of step S240. When the first region R1 is first allocated, there may be no segments SG loaded within the first region R1, making it unnecessary to determine whether the cache hit has occurred.

In some embodiments, one or more segments SG may correspond to the write request WREQ. For example, when two or more segments SG correspond to the write request WREQ, the memory controller 110 may determine whether a cache hit occurs for all segments SG. In other words, the memory controller 110 may determine whether a cache hit occurs based on whether all segments SG corresponding to the write request WREQ are loaded into the first region R1. The memory controller 110 may determine a cache miss in response to determining that at least one of the segments SG is not loaded into the first region R1.

In some embodiments, the memory controller 110 may determine whether a cache hit occurs when a portion (e.g., the first region R1) of the second cache memory 132 is allocated for the mapping information MP. The memory controller 110 may allocate the first region R1 for the mapping information MP when the size of the workload corresponding to the write request WREQ (or the number of segments SG) is less than or equal to a threshold value. Therefore, when the workload size (or the number of segments SG) corresponding to the write request WREQ is less than or equal to the threshold value, the memory controller 110 may determine whether a cache hit occurs for the segments SG. When the workload size (or the number of segments SG) is greater than the threshold value, the memory controller 110 may deallocate the first region R1 and perform a map update operation or update the mapping information MP.

In step S230, the memory controller 110 may modify the segment SG in response to a cache hit. For example, the memory controller 110 may modify the segment SG in response to determining that the segment SG corresponding to the write request WREQ has already been loaded in the first region R1. In some embodiments, when two or more segments SG correspond to the write request WREQ, the memory controller 110 may modify all segments SG.

In step S240, the memory controller 110 may update the mapping information MP in response to the cache miss. For example, in response to the cache miss, the memory controller 110 may update the mapping information MP by modifying a portion corresponding to the logical address and the physical address associated with the write request WREQ within the mapping information MP stored in the first cache memory 131.

In step S250, the memory controller 110 may load the segment SG into the first region R1. For example, after updating the mapping information MP corresponding to the write request WREQ, the memory controller 110 may load the segment SG corresponding to the write request WREQ into the first region R1. The memory controller 110 may reduce the overhead of the storage device 100 and improve overall write performance by loading the segment SG by a background operation after updating the mapping information MP, rather than immediately loading the segment SG into the first region R1 in response to the cache miss.

In some embodiments, when two or more segments SG correspond to the write request WREQ, the memory controller 110 may load all segments SG into the first region R1. When some of the two or more segments SG are already loaded into the first region R1, the memory controller 110 may load the remaining segments SG into the first region R1.

In some embodiments, after loading the segment SG into the first region R1, the memory controller 110 may invalidate a portion of the mapping information MP corresponding to the write request WREQ (or the segment SG).

The memory controller 110 may repeat steps S210 to S250. In some embodiments, after the segment SG is loaded in step S250, when a subsequent write request WREQ corresponding to the same segment SG is received, the memory controller 110 may modify the segment SG in response to a cache hit.

FIG. 6 is a diagram illustrating the storage device 100 according to some embodiments of the disclosed technology. Referring to FIG. 6, the memory controller 110 may deallocate a portion (e.g., the first region R1) of the second cache memory 132 allocated for the mapping information MP in response to determining that an event has occurred.

Referring to FIGS. 2 to 5, the memory controller 110 may allocate a portion (e.g., the first region R1) of the second cache memory 132 which stores segments (loaded during a read operation) for the mapping information MP. Instead of updating the mapping relationship between logical addresses and physical addresses corresponding to the write request WREQ in the mapping information MP, the memory controller 110 may store the segment corresponding to the write request WREQ in the first region R1. By doing so, the map update cycle can be increased and the performance of the storage device 100 can be improved.

However, indiscriminately allocating a portion of the second cache memory 132 for the mapping information MP may cause performance degradation. For example, as described below, allocating the portion of the second cache memory 132 for the mapping information MP when specific events occur may cause performance degradation.

In some embodiments, when the workload corresponding to the write request WREQ exhibits low locality, requiring the loading or modification of many segments, this may demand more overhead than the operation of updating the mapping information MP in the first cache memory 131 and result in inefficient space usage. For example, when the size of the workload corresponding to the write request WREQ (e.g., the number of segments) exceeds a threshold, loading or modifying the segments corresponding to the write request WREQ into a portion (e.g., the first region R1) of the second cache memory 132 may be inefficient.

In some embodiments, when the write request WREQ is a sequential write operation, it may be more efficient to update or store the mapping information MP in a different manner.

Furthermore, allocating the second cache memory 132 for the mapping information MP of write operations implies using an additional component (e.g., the second cache memory 132) besides the first cache memory 131 during a write operation, which may increase the overall power consumption of the storage device 100. Therefore, upon receiving a power reduction request from the external host device 11, allocating a portion (e.g., the first region R1) of the second cache memory 132 for the mapping information MP may be restricted or disallowed.

In some embodiments, when the storage device 100 performs internal operations requiring significant space in the second cache memory 132 (e.g., a garbage collection operation, a free-block operations, etc.), allocating a portion (e.g., the first region R1) of the second cache memory 132 for the mapping information MP may be restricted or disallowed.

The events described above are exemplary for illustrative purposes to aid in understanding the disclosed technology, and the scope of the disclosed technology is not limited thereto.

The memory controller 110 may deallocate the portion (e.g., the first region R1) of the second cache memory 132 in response to determining that an event (e.g., at least one of the above-described events which disallow or restrict the allocation of the portion of the second cache memory 132) has occurred. For example, the memory controller 110 may deallocate the first region R1 which has been allocated for the mapping information MP, and then, upon receiving a subsequent write request WREQ, may update the mapping information MP stored in the first cache memory 131.

In some embodiments, the memory controller 110 may set a portion (e.g., the first region R1) of the second cache memory 132 as unallocable for a specific time interval in response to determining that an event (e.g., at least one of the aforementioned events) has occurred. The unallocable state may refer to a state in which the portion (e.g., the first region R1) of the second cache memory 132 is not allocated for mapping information (MP), even when the requirements for the allocation for the mapping information MP are satisfied. Since the event may occur repeatedly during the specific time interval, the memory controller 110 may set a portion (e.g., the first region R1) of the second cache memory 132 as unallocable in response to the first occurrence of the event.

The memory controller 110 may perform a countdown operation to set a portion (e.g., the first region R1) of the second cache memory 132 as unallocable for a specific time interval. For example, in response to the deallocation of the first region R1, the memory controller 110 may perform a countdown operation and set the first region R1 as unallocable during the countdown operation.

After the countdown operation is completed (e.g., after the count reaches zero), the memory controller 110 may set the first region R1 as allocable or reallocate the first region R1 for the mapping information MP. When the first region R1 is in an allocable state, the memory controller 110 may allocate a portion (e.g., the first region R1) of the second cache memory 132 for the mapping information MP in response to determining that the requirements for allocating the first region R1 for the mapping information MP are satisfied.

In some embodiments, the memory controller 110 may perform a countdown operation for different time intervals (or counts) for each type of event. For example, in response to determining that a first type of event has occurred among a plurality of event types, the memory controller 110 may perform a countdown operation for a first time interval (or a first count). In response to determining that a second type of event has occurred, the memory controller 110 may perform a countdown operation for a second time interval (or a second count).

In some embodiments, the memory controller 110 may set a portion (e.g., the first region R1) of the second cache memory 132 which is in an unallocable state to be allocable as an exception during the countdown operation (e.g., before the countdown operation is completed or before the count reaches zero). Since the event may occur repeatedly over a specific time period, the memory controller 110 sets a portion (e.g., the first region R1) of the second cache memory 132 as unallocable during a specific time interval (e.g., until the countdown operation is completed). However, if there is low or no possibility of the event repeatedly occurring during a specific time interval, the memory controller 110 may set the portion (e.g., the first region R1) of the second cache memory 132, which is in an unallocable state, to be allocable without performing the countdown operation. For example, the memory controller 110 may set the portion (e.g., the first region R1) of the second cache memory 132 to be allocable after a predetermined time period after the event.

In some embodiments, the memory controller 110 may store information about sizes of workloads corresponding to subsequent write requests WREQ during the countdown operation (e.g., while the first region R1 is in the unallocable state). For example, the memory controller 110 may update information regarding whether each of the sizes of the workloads (or the number of segments) corresponding to subsequent write requests WREQ is less than or equal to a first threshold.

In some embodiments, the memory controller 110 may set the first region R1 as unallocable before the countdown operation completes, based on information about the sizes of workloads corresponding to the subsequent write requests WREQ. For example, the memory controller 110 may set the first region R1 as unallocable before the countdown operation is completed, in response to determining that the number of subsequent write requests WREQ including workloads (or the number of segments) smaller than or equal to the first threshold is greater than a second threshold.

The memory controller 110 may include a counter 111 and may store workload information WI. In some embodiments, the counter 111 performs the countdown operation, and when the countdown operation is completed (e.g., when the count reaches zero), the counter 111 may provide a signal indicating completion of the countdown operation to the memory controller 110. Furthermore, the memory controller 110 may store information about the sizes of the workloads corresponding to the subsequent write requests WREQ as the workload information WI.

In some embodiments, the memory controller 110 may perform a map update operation in response to determining that the remaining space in the first region R1 is less than a threshold. For example, since the space in the first region R1 is limited, the number of segments loaded into the first region R1 may be constrained. Therefore, by determining whether the remaining space in the first region R1 is less than the threshold, the memory controller 110 may determine whether additional segments may be loaded into the first region R1. When the remaining space in the first region R1 is smaller than the threshold, the memory controller 110 may perform a map update operation to flush all segments loaded into the first region R1 to the first memory device 120.

Operations to be described below (e.g., the first to seventh operations \textcircled{1} to \textcircled{7}) are exemplary for illustrating the disclosed technology and do not limit the scope of the disclosed technology.

In the first operation \textcircled{1}, the memory controller 110 may deallocate the first region R1. For example, the memory controller 110 may deallocate the first region R1 in response to determining that an event (e.g., at least one of the aforementioned events that disallow or restrict the allocation) has occurred.

In the second operation \textcircled{2}, the memory controller 110 may perform a map update operation. For example, the memory controller 110 may perform the map update operation in response to determining that an event has occurred and having deallocated the first region R1. To perform the map update operation, the memory controller 110 may control the second memory device 130 to flush the mapping information MP stored in the first cache memory 131 and the segments loaded into the first region R1 within the second cache memory 132 to the first memory device 120.

In the third operation \textcircled{3}, the second memory device 130 may perform a flush operation. For example, the second memory device 130 may flush the mapping information MP stored in the first cache memory 131 and the segments loaded into the first region R1 within the second cache memory 132 to the first memory device 120 under the control of the memory controller 110. After the flush operation is performed, the segment loaded into the first region R1 may no longer exist. The first memory device 120 may store the flushed mapping information MP and the segments as metadata MD.

In the fourth operation \textcircled{4}, the memory controller 110 or the counter 111 may perform a countdown operation. For example, the memory controller 110 or the counter 111 may perform the countdown operation in response to determining that the event has occurred. The memory controller 110 or the counter 111 may determine the count value for the countdown operation based on the type of event. Therefore, the memory controller 110 or the counter 111 may perform the countdown operation for different time intervals depending on the event type.

In the fifth operation \textcircled{5}, the memory controller 110 may set the first region R1 as unallocable during the countdown operation. Therefore, the memory controller 110 may not be able to reallocate the first region R1 for the mapping information MP until the countdown operation is completed (e.g., until the count reaches zero).

In the sixth operation \textcircled{6}, the memory controller 110 may store the workload information WI. For example, the memory controller 110 may store information about the sizes of workloads corresponding to the subsequent write requests WREQ during the countdown operation (e.g., while the first region R1 is in an unallocable state). For example, the memory controller 110 may update the workload information WI with information indicating whether the number of segments corresponding to each subsequent write request WREQ is less than or equal to a first threshold.

In the seventh operation \textcircled{7}, the memory controller 110 may determine whether to set the first region R1 as allocable, based on the workload information WI. For example, the memory controller 110 may determine whether to set the first region R1 as allocable before the countdown operation completes based on the workload information WI. For example, the memory controller 110 may determine, by referring to the workload information WI, whether the number of subsequent write requests WREQ including the number of segments less than or equal to the first threshold is greater than a second threshold, and based on the result, may determine whether to set the first region R1 as unallocable before the countdown operation completes.

FIG. 7 is a flowchart illustrating an operating method of the storage device 100 according to some embodiments of the disclosed technology. Referring to FIGS. 6 and 7, the memory controller 110 may set the first region R1 as unallocable, and exceptionally, set the first region R1 as unallocable again.

In step S310, the memory controller 110 may deallocate the first region R1. For example, the memory controller 110 may deallocate the first region R1 allocated for the mapping information MP in response to determining that an event (e.g., at least one of the events described in FIG. 6) has occurred.

In some embodiments, the memory controller 110 may perform a map update operation in response to deallocating the first region R1. For example, in response to deallocating the first region R1, the memory controller 110 may perform a map update operation to flush all segments corresponding to the write request WREQ loaded into the first region R1 to the first memory device 120.

In step S320, the memory controller 110 may perform a countdown operation. For example, the memory controller 110 may perform the countdown operation in response to determining that an event has occurred.

In some embodiments, the memory controller 110 may determine a count for countdown operations based on a type of event. For example, the memory controller 110 may perform the countdown operation for a first count duration when a first type of event occurs, and perform the countdown operation for a second count duration when a second type of event occurs. Therefore, the memory controller 110 or the counter 111 may perform the countdown operation for different time intervals depending on the event type.

In step S330, the memory controller 110 may set the first region R1 as unallocable. For example, the memory controller 110 may set the first region R1 as unallocable during the countdown operation. Therefore, the memory controller 110 may not be able to reallocate the first region R1 for the mapping information MP until the countdown operation is completed (e.g., until the count reaches zero).

In some embodiments, while the first region R1 is in an unallocable state, even when the requirements for allocating the first region R1 are satisfied (e.g., when the number of segments corresponding to the write request WREQ is less than or equal to a threshold value), the memory controller 110 may not allocate the first region R1 for the mapping information MP.

In step S340, the memory controller 110 may determine whether the count has reached zero. For example, the memory controller 110 may decrement the count by a unit amount during the countdown operation and determine whether the countdown operation is completed as the count has reached zero. The memory controller 110 may maintain the first region R1 in an unallocable state until the count reaches zero.

In step S350, the memory controller 110 may determine whether to set the first region R1 as allocable. For example, the memory controller 110 may determine to set the first region R1 as unallocable as an exception in response to determining that the count has not reached zero (e.g., the countdown operation has not completed).

In some embodiments, the memory controller 110 may store information about the sizes of workloads corresponding to the subsequent write requests WREQ during the countdown operation (e.g., while the first region R1 is in an unallocable state). The memory controller 110 may determine whether to set the first region R1 as allocable before the countdown operation completes, based on the information about the sizes of the workloads respectively corresponding to the subsequent write requests WREQ.

For example, the memory controller 110 may set the first region R1 as unallocable before the countdown operation completes in response to determining that the number of subsequent write requests WREQ including segments less than or equal to the first threshold is greater than the second threshold.

In response to determining not to set the first region R1 as allocable, the memory controller 110 may repeat and perform step S340. The memory controller 110 may again determine whether the count has reached zero.

In step S360, the memory controller 110 may set the first region R1 as allocable in response to determining that the count has reached zero or to having set the first region R1 as allocable. In response to determining that the requirement for allocating the first region R1 for the mapping information MP is satisfied, the memory controller 110 may reallocate the first region R1 for the mapping information MP.

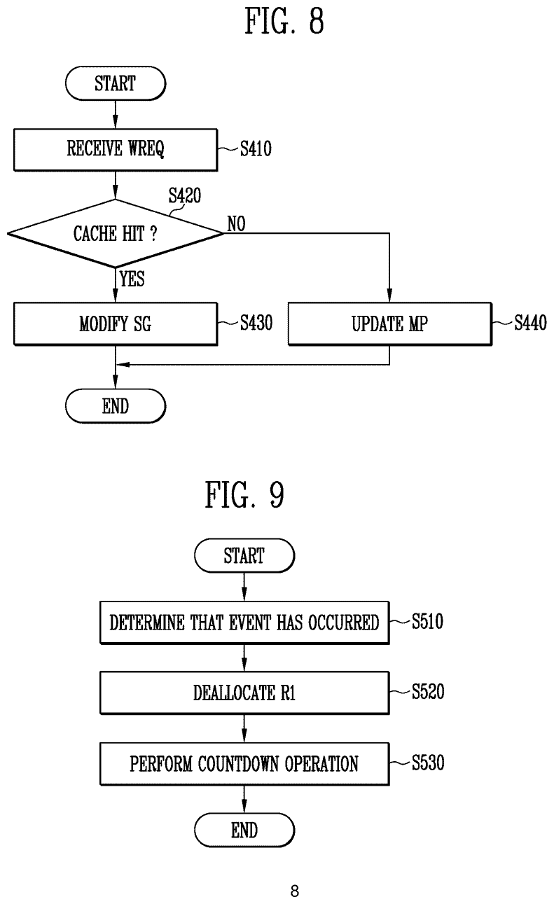

FIG. 8 is a flowchart illustrating an operating method of the storage device 100 according to some embodiments of the disclosed technology. Referring to FIGS. 2 and 8, the memory controller 110 may modify the segment SG loaded into the first region R1 based on whether a cache hit occurs, or may update the mapping information MP within the first cache memory 131.

In step S410, the memory controller 110 may receive the write request WREQ from the external host device 11. Before receiving the write request WREQ, the memory controller 110 may allocate some regions (e.g., the first region R1) of the second cache memory 132 for the mapping information MP corresponding to the write request WREQ. However, when processing the workload corresponding to the write request WREQ (e.g., when performing the write operation of the data DATA), the memory controller 110 may need to determine whether to update the mapping information MP in the first cache memory 131 or to modify the segment SG loaded into the first region R1.

In step S420, the memory controller 110 may determine whether a cache hit has occurred. For example, the memory controller 110 may determine whether a cache hit has occurred by determining whether the segment SG corresponding to the write request WREQ has already been loaded into the first region R1. Based on whether a cache hit occurs, the memory controller 110 may determine whether to update the mapping information MP of the first cache memory 131 or to modify the segment SG loaded into the first region R1.

In step S430, the memory controller 110 may modify the segment SG in response to the cache hit. For example, the memory controller 110 may modify the segment SG loaded into the first region R1 in response to the cache hit where it determines that the segment SG corresponding to the write request WREQ has already been loaded into the first region R1.

In step S440, the memory controller 110 may update the mapping information MP in response to the cache miss. For example, the memory controller 110 may update the mapping information MP stored in the first cache memory 131 in response to the cache miss which determines that the segment SG corresponding to the write request WREQ has not been loaded to the first region R1. In some embodiments, after updating the mapping information MP, the memory controller 110 may load the segment corresponding to the write request WREQ to the first region R1 as a background operation.

FIG. 9 is a flowchart illustrating an operating method of the storage device 100 according to some embodiments of the disclosed technology. Referring to FIGS. 6 and 9, the memory controller 110 may deallocate the first region R1 when an event occurs.

In step S510, the memory controller 110 may determine that an event, which disallows or restricts the allocation of the portion of the second cache memory for the mapping information MP, has occurred. For example, the memory controller 110 may determine that at least one of various types of events has occurred.

In some embodiments, the event may include at least one of determining that the size of the segment corresponding to the write request WREQ is greater than a threshold size, determining that the write request WREQ is a sequential write operation, or receiving a power reduction request from the external host device; however, these are exemplary and the scope of the disclosed technology is not limited thereto.

In step S520, the memory controller 110 may deallocate the first region R1. For example, the memory controller 110 may deallocate the first region R1 allocated for the mapping information MP in response to determining that an event (e.g., at least one of the event types described above) has occurred.

In step S530, the memory controller 110 may perform a countdown operation. For example, the memory controller 110 may perform the countdown operation in response to determining that the event has occurred. The memory controller 110 may set the first region R1 as unallocable during the countdown operation. Therefore, the memory controller 110 may not be able to reallocate the first region R1 for the mapping information MP until the countdown operation is completed (e.g., until the count reaches zero).

In some embodiments, the memory controller 110 may determine a count number of a countdown operation based on a type of event. For example, the memory controller 110 may perform a countdown operation for a first count number (e.g., until the count of the countdown operation reaches to the first count number) when a first type of event occurs, and may perform the countdown operation for a second count number (e.g., until the count of the countdown operation reaches to the second count number) when a second type of event occurs. Thus, the memory controller 110 may perform the countdown operation for different time intervals depending on the event type.

The memory controller 110 may prevent performance degradation of the storage device 100 due to unnecessary allocation of the first region R1 by setting the first region R1 as unallocable for different time intervals based on the event type.

FIG. 10 is a diagram illustrating a second memory device 230 according to some embodiments of the disclosed technology. Referring to FIG. 10, the second memory device 230 may include a cache memory 231. The cache memory 231 is exemplified by the first and second cache memories 131 and 132 implemented as a single cache memory as shown in FIG. 2. Therefore, redundant description thereof is omitted.

The cache memory 231 may store the mapping information MP and the segments SG. For example, the cache memory 231 may include first to third regions R1 to R3 distinguished by write pointers (e.g., first and second write pointers WP1 and WP2), and may store the mapping information MP and the segments SG within the first to third regions R1 to R3.

In some embodiments, the third region R3 may serve as a cache region for storing mapping information MP for write operations of the storage device 100 of FIG. 2, and the first and second regions R1 and R2 may serve as cache regions for storing the segments SG for a read operation of the storage device 100 of FIG. 2.

In some embodiments, the memory controller 110 of FIG. 2 may use the first region R1 among the first and second regions R1 and R2 to process the workload of the write request WREQ of the memory controller 110 of FIG. 2. For example, when requests received from the host device 11 in FIG. 2 are predominantly the write request WREQ or when the workload of read requests is small, the memory controller 110 in FIG. 2 may allocate some (e.g., the first region R1) of the first and second regions R1 and R2 for the mapping information MP, load the segments corresponding to the write request WREQ, and cache the segments.

In some embodiments, the sizes of regions (e.g., the first to third regions R1 to R3) within the cache memory 231 may be variable as needed. For example, the size of the third region R3 may increase as more mapping information MP is written to the first write pointer WP1 within the cache memory 231. In addition, the size of the first region R1 may increase as more segments SG corresponding to the write request WREQ are written to the second write pointer WP2 within the cache memory 231 (and as the segments SG stored within the second region R2 are overwritten).

In some embodiments, the storage device 100 of FIG. 2 may change the sizes of the first to third regions R1 to R3 when performing internal operations which require significant space in the second cache memory 132 (e.g., garbage collection operations, free-block operations, etc.). For example, the sizes of the second and third regions R2 and R3 may become larger, and the size of the third region R3 may become smaller. The sizes of the first to third regions R1 to R3 are not limited to the scale exemplarily shown in FIG. 10.

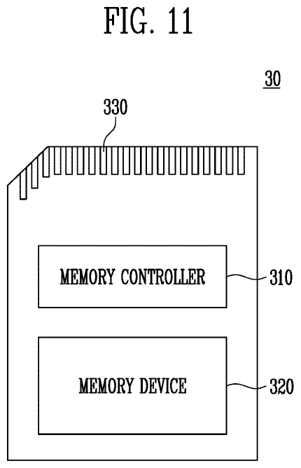

FIG. 11 is a block diagram illustrating a memory card system 300 to which a storage device according to some embodiments of the disclosed technology is applied. Referring to FIG. 11, the memory card system 300 may include a memory controller 310, a memory device 320, and a connector 330.

The memory controller 310 may be coupled to the memory device 320. The memory controller 310 may access the memory device 320. For example, the memory controller 310 may control program, read, erase, and background operations of the memory device 320. The memory controller 310 may provide an interface between the memory device 320 and a host. The memory controller 310 may drive firmware for controlling the memory device 320. The memory controller 310 may be configured in the same manner as the memory controller 110 as described above with reference to FIG. 1.

For example, the memory controller 310 may include components, such as a Random Access Memory (RAM), a processing unit, a host interface, a memory interface, and an ECC circuit.

The memory controller 310 may communicate with an external device through the connector 330. The memory controller 310 may communicate with an external device (e.g., a host device) based on a specific communication protocol. For example, the memory controller 310 may communicate with the external device through at least one of various communication protocols such as universal serial bus (USB), multimedia card (MMC), embedded MMC (eMMC), peripheral component interconnection (PCI), PCI-express (PCI-E), advanced technology attachment (ATA), serial-ATA (SATA), parallel-ATA (PATA), small computer system interface (SCSI), enhanced small disk interface (ESDI), integrated drive electronics (IDE), Firewire, universal flash storage (UFS), WiFi, Bluetooth, and/or non-volatile memory express (NVMe) protocols. In an embodiment, the connector 330 may be defined by at least one of the above-described various communication protocols.

The memory device 320 may be implemented with various types of nonvolatile memory elements, such as Electrically Erasable and Programmable Read-Only Memory (EEPROM), NAND flash memory, NOR non-volatile memory, Phase-change RAM (PRAM), Resistive RAM (ReRAM), Ferroelectric RAM (FRAM), or Spin Transfer Torque Magnetic RAM (STT-MRAM).

The memory controller 310 and the memory device 320 may be integrated into a single semiconductor device to form a memory card. For example, the memory controller 310 and the memory device 320 may be integrated into a single semiconductor device to form a memory card, such as a personal computer memory card international association (PCMCIA) card, a compact flash (CF) card, a smart media card (SM, or SMC), a memory stick, a multimedia card (MMC, RS-MMC, MMCmicro, or eMMC), an SD card (SD, miniSD, microSD, or SDHC), a universal flash storage (UFS), or others.

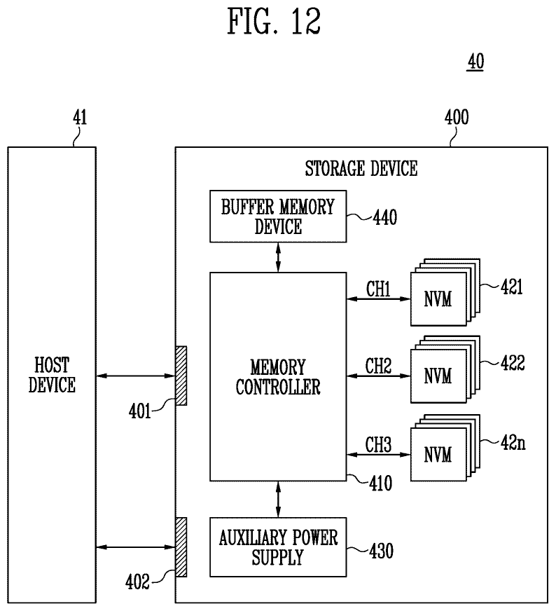

FIG. 12 is a block diagram illustrating an electronic system 40 according to embodiments of the disclosed technology. Referring to FIG. 12, the electronic system 40 may include a host device 41 and a storage device 400. The storage device 400 may exchange signals with the host device 41 through a signal connector 401 and may receive power through a power connector 402. The storage device 400 may include a memory controller 410, a plurality of non-volatile memories 421 to 42n, an auxiliary power supply 430, and a buffer memory device 440.

According to an embodiment, the memory controller 410 may function as the memory controller 110 as described above with reference to FIG. 1.

The memory controller 410 may control the plurality of non-volatile memories 421 to 42n in response to signals received from the host device 41. In an embodiment, the signals may be based on the interfaces of the host device 41 and the storage device 400. For example, the signals may be defined by at least one of various interfaces such as universal serial bus (USB), multimedia card (MMC), embedded MMC (eMMC), peripheral component interconnection (PCI), PCI-express (PCI-E), advanced technology attachment (ATA), serial-ATA (SATA), parallel-ATA (PATA), small computer system interface (SCSI), enhanced small disk interface (ESDI), integrated drive electronics (IDE), Firewire, universal flash storage (UFS), WiFi, Bluetooth, or non-volatile memory express (NVMe) interfaces.

The auxiliary power supply 430 may be coupled to the host device 41 through the power connector 402. The auxiliary power supply 430 may be supplied and charged with the power from the host device 41. The auxiliary power supply 430 may supply the power of the storage device 400 when the power is not smoothly supplied from the host device 41. In an embodiment, the auxiliary power supply 430 may be positioned inside or outside the storage device 400. For example, the auxiliary power supply 430 may be disposed in a main board and supply auxiliary power to the storage device 400.

The buffer memory device 440 may serve as a buffer memory of the storage device 400. For example, the buffer memory device 440 may temporarily store data received from the host device 41 or data received from the plurality of non-volatile memories 421 to 42n, or may temporarily store metadata (e.g., mapping information or segments) of the non-volatile memories 421 to 42n. The buffer memory device 440 may include volatile memories such as DRAM, SDRAM, DDR SDRAM, and LPDDR SDRAM, or non-volatile memories such as FRAM, ReRAM, STT-MRAM, and PRAM.

According to the disclosed technology, a storage device that allocates a portion of a cache memory for data stored in another cache memory and an operating method of the storage device is provided.

In addition, a storage device that increases a map update cycle and provides improved write performance by allocating a portion of another cache memory for a workload satisfying a locality condition, and an operating method of the storage device is provided.

Only examples for implementing embodiments of the disclosed technology are described. Variations of the disclosed examples of the embodiments and other embodiments may be made based on what is disclosed in this patent document.

What is claimed is:

1. A storage device, comprising:
a first memory device configured to store data;
a second memory device including a first cache memory configured to store mapping information between physical data addresses and logical data addresses of the stored data and a second cache memory configured to store segments of the mapping information; and
a memory controller in communication with the first memory device and the second memory device and configured to update the mapping information in response to a write request received from an external host device,
wherein the memory controller is configured to allocate a first region among regions of the second cache memory for the mapping information in response to determining that a size of a workload corresponding to the write request is less than or equal to a first threshold value.

2. The storage device of claim 1, wherein the memory controller is configured to:
determine whether a cache hit or a cache miss occurs for a segment corresponding to the write request,
modify the segment in response to the cache hit for the segment, and
update the mapping information in response to the cache miss for the segment.

3. The storage device of claim 2, wherein the memory controller is further configured to load the segment into the first region after updating the mapping information.

4. The storage device of claim 3, wherein the memory controller is configured to load the segment into the first region, and invalidate a portion of the mapping information corresponding to the segment in response to receiving a write request corresponding to the segment.

5. The storage device of claim 1, wherein the memory controller is configured to deallocate the first region in response to determining that a size of a workload corresponding to the write request is greater than the first threshold value.

6. The storage device of claim 5, wherein the memory controller is configured to perform a map update operation in response to deallocating the first region.

7. The storage device of claim 5, wherein the memory controller is configured to:
perform a countdown operation in response to deallocating the first region, and
set the first region as unallocable during the countdown operation.

8. The storage device of claim 7, wherein the memory controller is further configured to:
store information about sizes of workloads corresponding to subsequent write requests, respectively, during the countdown operation, and
determine, based on the information, whether to set the first region as allocable before the countdown operation is completed.

9. The storage device of claim 1, wherein the memory controller is further configured to deallocate the first region in response to determining that the write request indicates a sequential write operation.

10. The storage device of claim 1, wherein the write request indicates a random write operation.

11. The storage device of claim 1, wherein the memory controller performs a map update operation in response to determining that a remaining space of the first region is less than a second threshold value.

12. The storage device of claim 1, wherein the memory controller is configured to:
in response to receiving a read request from the external host device, determine whether a cache hit occurs for a segment corresponding to the read request, and
in response to the cache hit for the segment, perform a read operation for read data corresponding to the segment.

13. A storage device, comprising:
a first memory device configured to store data;
a second memory device including a first cache memory configured to store mapping information between physical data addresses and logical data addresses of the stored data and a second cache memory configured to store segments of the mapping information; and
a memory controller in communication with the first memory device and the second memory device and configured to allocate a first region among regions of the second cache memory for the mapping information,
wherein the memory controller is configured to:
in response to receiving a write request from an external host device, determine whether a cache hit or a cache miss occurs for a segment corresponding to the write request,
modify the segment in response to the cache hit for the segment, and
update the mapping information in response to the cache miss for the segment.

14. The storage device of claim 13, wherein the memory controller is further configured to:
load the segment into the first region after updating the mapping information, and
invalidate a portion of the mapping information corresponding to the segment in response to receiving the write request corresponding to the segment after loading the segment into the first region.

15. The storage device of claim 13, wherein the memory controller is configured to:
deallocate the first region and perform a countdown operation in response to an occurrence of an event, and
set the first region as unallocable during the countdown operation.

16. The storage device of claim 15, wherein a type of the event comprises at least one of:
determining that a size of the segment is greater than a threshold size;
the write request being a sequential write operation; and
receiving a power reduction request from the external host device.

17. The storage device of claim 15, wherein the memory controller determines a count number of the countdown operation, based on a type of the event.

18. The storage device of claim 15, wherein the memory controller is configured to:
store information about sizes of workloads respectively corresponding to subsequent write requests during the countdown operation, and
determine, based on the information, whether to set the first region as allocable before the countdown operation is completed.

19. The storage device of claim 13, wherein the memory controller is configured to:
in response to receiving a read request from the external host device, determine whether a cache hit occurs for a segment corresponding to the read request, and
in response to the cache hit for the segment, perform a read operation for read data corresponding to the segment.

20. A method of operating a storage device, the method comprising:
allocating a first region among regions of a second cache memory storing segments for mapping information of a first cache memory storing the mapping information;
receiving a write request from an external host device;
determining whether a cache hit occurs for a segment corresponding to the write request in the first region in response to receiving the write request;
modifying the segment in response to the cache hit for the segment; and
updating the mapping information in response to a cache miss for the segment.
